(19) United States
(12) Patent Application Publication
(10) Pub. No.: US 2020/0193985 A1
(43) Pub. Date: Jun. 18, 2020

(54) DOMAIN MANAGEMENT METHOD OF SPEECH RECOGNITION SYSTEM

(71) Applicants: HYUNDAI MOTOR COMPANY, Seoul (KR); KIA MOTORS CORPORATION, Seoul (KR)

(72) Inventors: Kyung Chul Lee, Seongnam-si (KR); Jae Min Joh, Yongin-si (KR)

(73) Assignees: HYUNDAI MOTOR COMPANY, Seoul (KR); KIA MOTORS CORPORATION, Seoul (KR)

(21) Appl. No.: 16/415,547

(22) Filed: May 17, 2019

(30) Foreign Application Priority Data
Dec. 12, 2018 (KR) 10-2018-0159723

(51) Int. Cl. G10L 15/22

(52) U.S. Cl. CPC G10L 15/22; G10L 15/1815; G10L 2015/226; G10L 2015/223

(57) ABSTRACT

A method of managing a domain for a speech recognition system includes may include: collecting, by a vehicle function analysis module, speech recognition function information from a system mounted on a vehicle; collecting, by a vehicle situation analysis module, situation information from the system mounted on the vehicle; and managing, by a user domain management module, a user domain based on the speech recognition function information and the situation information collected.

### CROSS-REFERENCE TO RELATED APPLICATION

This application claims priority to and the benefit of Korean Patent Application No. 10-2018-0159723, filed on Dec. 12, 2018, the entire contents of which are incorporated herein by reference.

### FIELD

The present disclosure relates to a technology for managing a domain used for speech recognition.

### BACKGROUND

The statements in this section merely provide background information related to the present disclosure and may not constitute prior art.

Speech recognition technology is a technique for extracting a feature from a speech signal, applying a pattern recognition algorithm to the extracted feature, and then back-tracking the speech signal to know which phoneme or word string is generated by a speaker's utterance. Recently, various schemes for improving the accuracy of speech recognition have been proposed. A speech recognition scheme using speech act information estimates a speech act based on the recognition result obtained in a primary speech recognition process and then searches the final recognition result by using a language model specified to the estimated speech act. However, according to the scheme, when the speech act estimation error occurs due to the error accompanying the recognition result obtained in the primary speech recognition process, there is a high possibility that an incorrect final recognition result is derived.

As another scheme, for example, a domain-based speech recognition technology has been widely used, in which a plurality of domains are classified according to topics such as weather, sightseeing, and the like, an acoustic model and a language model specified to each domain are generated, and then a given speech signal is recognized by using the acoustic and language models. According to this scheme, when a speech signal is input, speech recognition is performed in parallel on a plurality of domains to generate recognition results, and then the recognition result with the highest reliability among the plurality of recognition results is finally selected.

Because the domain-based speech recognition technology needs to perform semantic analysis for all domains, the processing speed is slowed down as the number of domains increases. In this case, there is a high possibility that the voice command of a user may not be accurately interpreted, so that it may be impossible to obtain a high-accuracy result. Accordingly, a guidance message is presented to the user, such as “It is not recognized, please input again” or the result obtained through web search as an exceptional process. In this case, because the exceptional process provides a low accuracy result, the reliability of speech recognition performance deteriorates as the number of exception processes increases.

### SUMMARY

An aspect of the present disclosure provides a domain management method of a speech recognition system, which is capable of reducing or preventing a delay of a processing speed caused by performing semantic analysis on all domains and an increase of exceptional processes due to a low accuracy of semantic analysis result, by generating a domain (hereinafter, referred to as a user domain) optimized for a user based on a function and a situation of a vehicle, and managing the user domain by reflecting a user's selection of an exceptionally processed result that is not normally recognized.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a method of managing a domain for a speech recognition system includes: collecting, by a vehicle function analysis module, speech recognition function information from a system mounted on a vehicle; collecting, by a vehicle situation analysis module, situation information from the system mounted on the vehicle; and managing, by a user domain management module, a user domain based on the speech recognition function information and the situation information collected.

The user domain may include a plurality of main domains, and each main domain of the plurality of main domains may include a plurality of subdomains.

The managing of the user domain may include activating or inactivating a specific main domain among the plurality of main domains; and activating or inactivating a specific subdomain among the plurality of subdomains.

The method may further include determining whether to activate a main domain of the plurality of main domains and a subdomain of the plurality of subdomains based on user preference information collected from the system mounted on the vehicle.

The determining of whether to activate the main domain and the subdomain may include determining whether to activate the main domain and the subdomain based on a menu priority by the user as the user preference information.

The determining of whether to activate the main domain and the subdomain may include determining whether to activate the main domain and the subdomain based on a favorite set by the user as the user preference information.

The determining of whether to activate the main domain and the subdomain may include determining whether to activate the main domain and the subdomain based on a menu priority and a favorite set by the user as the user preference information.

The plurality of main domains may include at least one of communication, navigation, media, knowledge, news, sports, or weather.

The collecting of the situation information may include collecting at least one of a parking state or a stop state, a navigation setting state, an information receiving state, or a phone connecting state of the vehicle.

The method may further include analyzing, by the vehicle situation analysis module, frequency of use of each main domain of the plurality of main domains in each situation based on the collected situation information, and assigning a weight to each main domain corresponding to the analyzed frequency of use.

The collecting of the speech recognition function information may include collecting the speech recognition function information from an audio video navigation (AVN) system provided in the vehicle.

The managing of the user domain may include managing each user domain with respect to a plurality of users.

The method may further include further managing, by an exception processing management module, the user domain by reflecting a user selection of an exceptionally processed result.

The managing of the user domain by reflecting the user selection may include assigning a weight to a domain selected by the user.

The managing of the user domain by reflecting the user selection may include generating an exception processing model ‘1’ based on a user selection of an exceptionally processed result of an ambiguous command, and generating an exception processing model ‘2’ based on a user selection of an exceptionally processed result of an unsupported command.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a conceptual view illustrating a domain management process of a speech recognition system;

FIG. 2 is a view illustrating a user domain model generated for a plurality of users;

FIG. 3 is a view illustrating a configuration of an exception processing management module;

FIG. 4 is a flowchart illustrating a method of managing a domain for a speech recognition system; and

FIG. 5 is a block diagram illustrating a computing system for executing a domain management method of a speech recognition system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Further, in describing the form of the present disclosure, a detailed description of well-known features or functions will be ruled out in order not to unnecessarily obscure the gist of the present disclosure.

In describing the components of the form according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

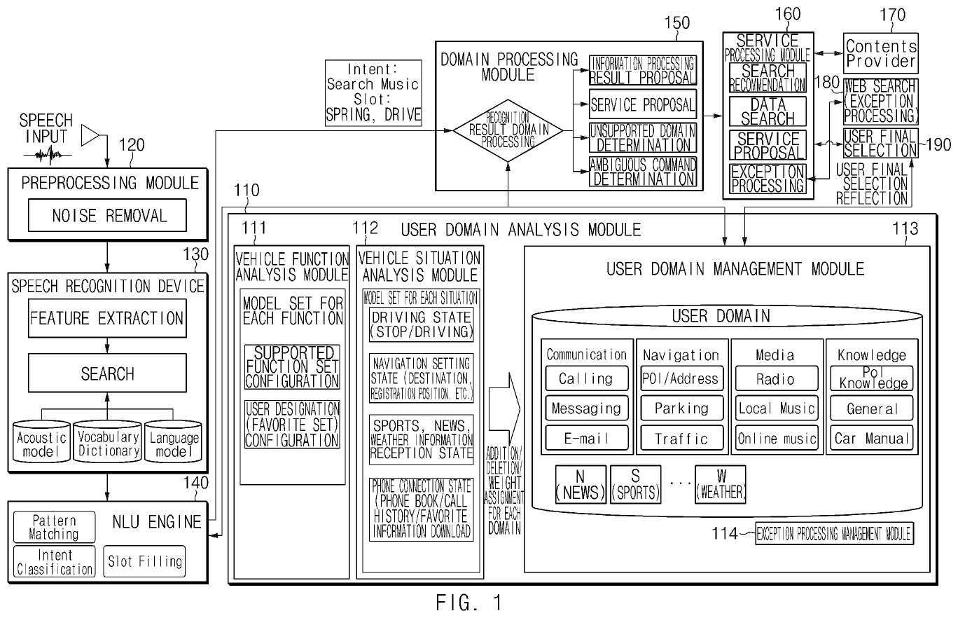

FIG. 1 is a conceptual view illustrating a domain management process of a speech recognition system according to one form of the disclosure, and shows functional blocks of a processor of a speech recognition system applied to a vehicle.

First, a user domain analysis module 110 is a functional block for generating a domain (hereinafter referred to as a user domain) optimized for a user based on a function and a situation of a vehicle (an operating state of a system provided in the vehicle) and managing the user domain by reflecting the user selection of an exceptionally processed result that is not normally recognized. The user domain analysis module 110 may include a vehicle function analysis module 111, a vehicle situation analysis module 112, a user domain management module 113, and an exception processing management module 114.

The vehicle function analysis module 111, which is a functional block for constructing a model set for each function, has a function set related to speech recognition provided by the vehicle. That is, speech recognition-related function information is collected from various systems installed in the vehicle. For example, a domain set for functions related to speech recognition provided by an audio video navigation (AVN) system of the vehicle may be configured.

The vehicle function analysis module 111 may include a main domain and a subdomain based on functions supported by an in-vehicle system. In this case, the support function set may be constituted as follows.
1) Calling function—supported
2) Messaging function—supported when an Android phone is connected, unsupported when an I-phone is connected
3) E-mail function—unsupported
4) Car manual providing—supported
5) Online music providing—supported when a user subscribes to an online music site and permits to link

The vehicle function analysis module 111 may include a domain reflecting user preference such as menu priority, a favorite, and the like set by the user. For example, it is possible to increase the weight of a domain that corresponds to a high-priority menu or corresponds to a function included in the favorite. For reference, the higher the weight of the domain is, the higher the probability of being derived as a speech recognition result.

The vehicle situation analysis module 112, which is a functional block for constructing a model set for each situation, may collect vehicle situation information from various systems mounted on the vehicle. For example, situation information, such as a driving state (stop, parking), a navigation setting state (destination, registration location, favorite, and the like), an information (sports, news, weather, and the like) receiving state, a phone connection state (phone book, call history, favorite, data download), and the like, may be collected.

The vehicle situation analysis module 112 may analyze the frequency of use of each main domain and each sub-domain corresponding to the driving state, and assign a weight to each main domain and each sub-domain.

For example, when the frequency of use of a domain frequently used by a user is 50% for communication, 30% for media, 10% for news, and 10% for navigation, a weight may be assigned corresponding to the frequency of use. In this case, a domain having a weight value of ‘0 (zero)’ is disabled during driving.

As another example, when the frequency of use of a domain frequently used by the user which the vehicle is stopped is 50% for navigation search, 30% for knowledge search, and 20% for news, a weight may be assigned corresponding to the frequency of use. In this case, a domain having a weight value of ‘0’ is disabled during driving.

As still another example, the communication domain is disabled when the phone is not connected, and the corresponding communication domain and the subdomain may be weighted corresponding to the frequency of using the phone while driving.

The vehicle situation analysis module 112 may determine whether to activate the main domain and the subdomain by analyzing the above-described situations in a combining manner, and assign a weight to the main domain and the subdomain.

The user domain management module 113, which is a functional block for managing a user domain, manages a user domain model.

As shown in FIG. 1, the user domain model may include a communication domain, a navigation domain, a media domain, a knowledge domain, a news domain, a sports domain, a weather domain, and the like. In this case, the communication domain may include calling, messaging, and e-mail as a subdomain, and the navigation domain may include position-of-interest (POI)/address, parking, and traffic as a subdomain. The media domain may include radio, local music, online music as a subdomain, and the knowledge domain may include POI knowledge, general, and car manual as a subdomain. In this case, the news domains, the sports domain, and the weather domain are in a disabled state as the main domains, and the e-mail, radio, and general are also in a disabled state as the subdomains.

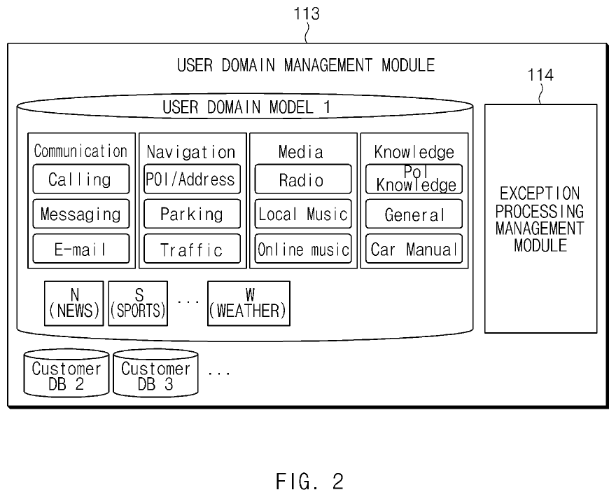

When constructed in the server, the user domain management module 113 may generate and manage a user domain model optimized for a corresponding user for a plurality of users. That is, as shown in FIG. 2, the user domain management module 113 may generate and manage a customer DB ‘2’ for storing a second user domain model, a customer DB ‘3’ for storing a third user domain model, and the like.

The exception processing management module 114, which is a functional block for managing the user domain by reflecting a user selection of an exceptionally processed result that is not normally recognized, may be classified into an unsupported domain and an ambiguous command and may collect data on an exceptionally processed case.

The exception processing management module 114 may collect corpuses for unsupported commands or supportable but ambiguous utterances among domains that are supportable based on the collected data, and distinguish the unsupported and ambiguous commands by using the corpuses, so that it is possible to provide guidance to the user when a command separated as the unsupported command is uttered.

When a user selection exists among the results of exceptionally processed ambiguous utterance, the exception processing management module 114 may assign an additional weight to the corresponding domain such that the semantic analysis is performed in the corresponding domain.

For example, a main keyword for grasping intension of a natural language for each domain, such as ‘Please find Starbucks’, ‘Starbucks guide’, ‘Starbucks where’, and the like, is desired to recognize the corresponding domain. There is no vocabulary in a sample utterance of a user such as ‘Starbucks?’ to know what the user utterance means. In this case, exception processing may be performed, and when the user selects map search from the exceptional result or searches for ‘Starbucks’ through navigation, the exception processing management module 114 may assign a weight to the navigation domain. Thus, the navigation guide may be performed immediately after “Starbucks?” is input.

When there is a user selection in the result of exception processing due to the utterance of an unsupported command, the exception processing management module 114 may assign an additional weight to the corresponding domain so that the semantic analysis is performed in the corresponding domain.

For example, although a user clearly utters ‘spring sky’, when it is impossible to grasp the intention, spring weather information of a weather domain and fine dust information of a search domain may be provided. When the user selects the weather domain, a weight may be assigned to the weather domain, and then, the spring weather information may be provided when ‘spring sky’ is input. By expanding it, even when similar utterance such as ‘autumn sky’, ‘summer rain’, or the like occurs, it is possible to provide fall weather or summer weather through the weather domain.

After all, when the service result in response to a speech command of the user does not meet the intention of the user, the exception processing management module 114 may manage a user domain based on the selection of the user.

Next, a preprocessing module 120 removes the noise of the voice input from the user.

Next, a speech recognition device 130 recognizes the speech uttered by the user from the input speech signal, and outputs the recognition result. The recognition result output from the speech recognition device 130 may be text-type utterance.

The speech recognition device 130 may include an automatic speech recognition (ASR) engine. The ASR engine may recognize speech uttered by the user by applying a speech recognition algorithm to the input speech, and may generate a recognition result.

In this case, the input speech may be converted into a more useful form for speech recognition, and thus, a start point and an end point may be detected in the speech signal to detect an actual speech section of the input speech. This is called end point detection (EPD). In addition, a feature vector extraction technique such as cepstrum, linear predictive coding (LPC), Mel frequency cepstral coefficient (MFCC), filter bank energy, or the like may be applied within the detected section, thereby extracting a feature vector of the input speech. In addition, the recognition result may be obtained by comparing the extracted feature vector with a trained reference pattern. To this end, an acoustic model for modeling and comparing the signal features of speech and a language model for modeling the linguistic order relation of words or syllables corresponding to a recognition vocabulary may be used.

The speech recognition device 130 may use any schemes for recognizing speech. For example, an acoustic model to which a hidden Markov model is applied may be used, or an N-best search scheme combining an acoustic model and a voice model may be used. After selecting up to N recognition result candidates using an acoustic model and a language model, N-best search scheme may improve the recognition performance by re-evaluating the ranking of the candidates.

The speech recognition device 130 may calculate a confidence value to secure the reliability of the recognition result. The confidence value is a measure of how reliable the speech recognition result is. For example, a phoneme or word which is a recognition result may be defined as a relative value of the probability that the word has been uttered from another phoneme or word. Therefore, the confidence value may be expressed as a value between ‘0’ and ‘1’, or as a value between ‘0’ and ‘100’.

When the confidence value exceeds a preset threshold value, the recognition result may be output to perform an operation corresponding to the recognition result. When the confidence value is equal to or less than the threshold value, the recognition result may be rejected.

The text-type utterance, which is the recognition result of the speech recognition device 130, is input to a natural language understanding (NLU) engine 140.

The NLU engine 140 may grasp the utterance intention of the user included in the utterance language by applying a natural language understanding technology. That is, the NLU engine 140 may analyze the meaning of the utterance language.

The NLU engine 140 performs morpheme analysis on the text-type utterance. A morpheme, which is the smallest unit of meaning, represents the smallest semantic element that can no longer be subdivided. Thus, the morpheme analysis, which is a first step in understanding natural language, converts an input string into a morpheme string.

The NLU engine 140 extracts a domain from utterance based on a morpheme analysis result. The domain, which is a domain that can identify a subject of a user utterance language, represents various topics such as route guidance, weather search, traffic search, schedule management, refueling guidance, air control, and the like.

The NLU engine 140 may recognize an entity name from the utterance. The entity name is a proper name such as a name, a place name, an organization name, a time, a date, a money, or the like and an entity name recognition is a work for identifying an entity name in a sentence and determining a kind of the entity name. The meaning of a sentence may be grasped by extracting an important keyword from the sentence through the entity name recognition.

The NLU engine 140 may analyze an action of utterance. The utterance action analysis, which is a work of analyzing the intention of user utterance, grasps the intention of the sentence about whether a user asks a question, requests something, or simply expresses emotion.

The NLU engine 140 extracts an action corresponding to the utterance intention of the user. The utterance intention of the user is grasped based on information such as a domain, an entity name, an utterance action, and the like corresponding to the utterance, and an action corresponding to the utterance intention is extracted.

The processing result of the NLU engine 140 may include, for example, a domain and a keyword corresponding to the utterance, and may further include a morpheme analysis result, an entity name, action information, utterance action information, and the like.

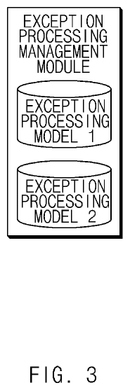

Next, a domain processing module 150 selects a user domain model and an exception processing model to be referred to by the NLU engine 140. In this case, as shown in FIG. 3, the exception processing model, which is a model managed by the exception processing management module 114, means exception processing model ‘1’ generated based on the user selection of an exception processing result of an ambiguous command and exception processing model ‘2’ generated based on the user selection of the exception processing result of an unsupported command.

The domain processing module 150 may propose an information processing result based on the recognition result (e.g., Intent: search music, Slot: spring and drive) by the NLU engine 140, propose a service, or determine the recognition result as an unsupported domain or an ambiguous command.

Next, a service processing module 160 recommends search, performs data search, suggests a service, or performs exception processing, based on the processing result of the domain processing module 150.

The service processing module 160 may acquire contents from a content provider (CP) 170 and provide the contents to a user.

The service processing module 160 may perform web search 180 as exception processing. In this case, the final selection 190 of the user according to the exception processing may be transmitted to the exception processing management module 114 to generate an exception processing model.

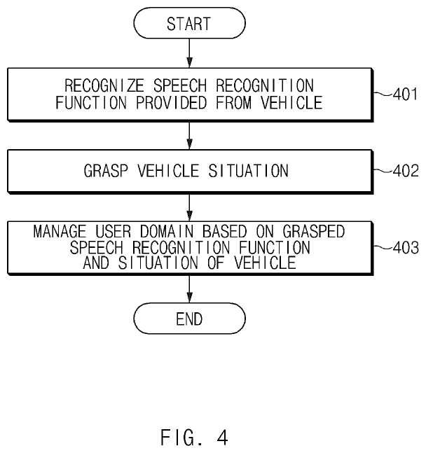

FIG. 4 is a flowchart illustrating a method of managing a domain for a speech recognition system according to an exemplary form of the disclosure, which may be performed by a processor included in the speech recognition system or a separate processor.

First, in operation 401, the speech recognition function provided by a vehicle is recognized. That is, speech recognition function information is collected from the system mounted on the vehicle.

Then, in operation 402, the situation of the vehicle is grasped. That is, situation information is collected from the system mounted on the vehicle.

Thereafter, in operation 403, the user domain is managed based on the grasped speech recognition function and situation of the vehicle. That is, the user domain is managed based on the collected speech recognition function information and situation information.

Through the process described above, it is possible to prevent the delay of the processing speed caused by performing the semantic analysis on all domains and the increase of the exception processing due to the low accuracy of the semantic analysis result.

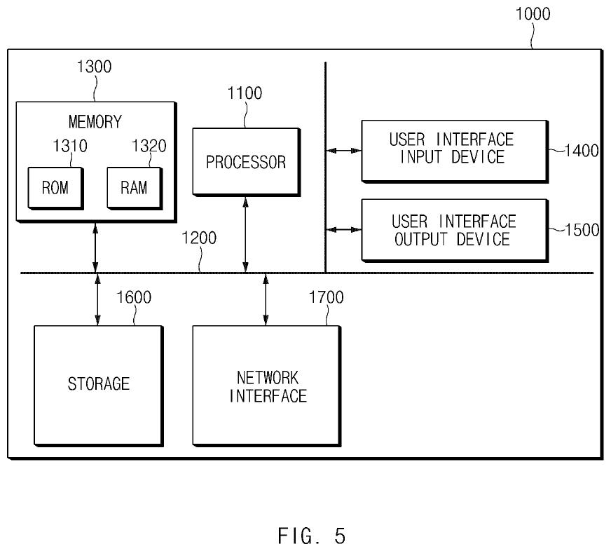

FIG. 5 is a block diagram illustrating a computing system for executing a domain management method of a speech recognition system according to another form of the disclosure.

Referring to FIG. 5, the domain management method of the speech recognition system may be implemented through a computing system. A computing system 1000 may include at least one processor 1100, a memory 1300, a user interface input device 1400, a user interface output device 1500, storage 1600, or a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the forms disclosed herein may be embodied directly in hardware or a software module executed by the processor 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a solid state drive (SSD), a removable disk, a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to the domain management method of a speech recognition system of the disclosure, a domain (a user domain) optimized for a user may be generated based on a function and a situation of a vehicle, and the user domain may be managed by reflecting a user's selection of an exceptionally processed result that is not normally recognized, so that it is possible to prevent a delay of a processing speed caused by performing semantic analysis on all domains and an increase of exceptional processes due to a low accuracy of semantic analysis result.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

Therefore, the exemplary forms of the present disclosure are provided to explain the spirit and scope of the present disclosure, but not to limit them, so that the spirit and scope of the present disclosure is not limited by the forms. The scope of the present disclosure should be construed on the basis of the accompanying claims, and all the technical ideas within the scope equivalent to the claims should be included in the scope of the present disclosure.

What is claimed is:

1. A method of managing a domain for a speech recognition system, the method comprising:
collecting, by a vehicle function analysis module, speech recognition function information from a system mounted on a vehicle;
collecting, by a vehicle situation analysis module, situation information from the system mounted on the vehicle; and
managing, by a user domain management module, a user domain based on the speech recognition function information and the situation information collected.

2. The method of claim 1, wherein the user domain includes a plurality of main domains, and
wherein each main domain of the plurality of main domains includes a plurality of subdomains.

3. The method of claim 2, wherein managing the user domain includes:
activating or inactivating a specific main domain among the plurality of main domains; and
activating or inactivating a specific subdomain among the plurality of subdomains.

4. The method of claim 2, further comprising:
determining whether to activate a main domain of the plurality of main domains and a subdomain of the plurality of subdomains based on user preference information collected from the system mounted on the vehicle.

5. The method of claim 4, wherein determining whether to activate the main domain and the subdomain includes:
determining whether to activate the main domain and the subdomain based on a menu priority or a favorite set by the user as the user preference information.

6. The method of claim 2, wherein the plurality of main domains include at least one of communication, navigation, media, knowledge, news, sports, or weather.

7. The method of claim 2, wherein collecting the situation information includes:
collecting at least one of a parking state or a stop state, a navigation setting state, an information receiving state, or a phone connecting state of the vehicle.

8. The method of claim 7, further comprising:
analyzing, by the vehicle situation analysis module, frequency of use of each main domain of the plurality of main domains in each situation based on the collected situation information, and assigning a weight to each main domain based on the analyzed frequency of use.

9. The method of claim 1, wherein collecting the speech recognition function information includes:
collecting the speech recognition function information from an audio video navigation (AVN) system provided in the vehicle.

10. The method of claim 1, wherein managing the user domain includes:
managing each user domain with respect to a plurality of users.

11. The method of claim 1, further comprising:
managing, by an exception processing management module, the user domain by reflecting a user selection of an exceptionally processed result.

12. The method of claim 11, wherein managing the user domain by reflecting the user selection includes:
assigning a weight to a domain selected by the user.

13. The method of claim 11, wherein managing the user domain by reflecting the user selection includes:
generating an exception processing model ‘1’ based on a user selection of an exceptionally processed result of an ambiguous command; and
generating an exception processing model ‘2’ based on a user selection of an exceptionally processed result of an unsupported command.
